(19) United States
(12) Patent Application Publication
(10) Pub. No.: US 2008/0272531 A1
(43) Pub. Date: Nov. 6, 2008

(54) Folding device and corresponding printing press

(75) Inventor: Jilani Chrigui, Creil (FR)

Correspondence Address: Davidson, Davidson & Kappel, LLC, 485 7th Avenue, 14th Floor, New York, NY, 10018, US

(73) Assignee: GOSS INTERNATIONAL MONTATAIRE SA, Montataire (FR)

(21) Appl. No.: 12/148,441

(22) Filed: Apr. 18, 2008

(30) Foreign Application Priority Data
Apr. 27, 2007 (FR) 07 54752

(51) Int. Cl. B42C 1/00; B41F 9/02

(52) U.S. Cl. 270/45; 101/152

(57) ABSTRACT

A device for folding flat products including a rotor which can rotate freely about a centre axis, a first blade and a second blade for folding one of the flat products arranged on the rotor, first device for moving the first folding blade relative to the rotor between a passage position and a folding position. The folding device may include a second device for moving the second folding blade relative to the rotor between a passage position and a folding position.

This claims the benefit of French Application 07 54752 filed on Apr. 27, 2008, the entire specification of which is hereby incorporated by reference herein.

The present invention relates to a device for folding flat products, including signatures.

### BACKGROUND TO THE INVENTION

Document DE 102 10 030 discloses a rotary folding device which comprises a rotor on which a single folding blade is arranged. The single folding blade is mounted so as to rotate about this rotor. A central toothed wheel which is fixed relative to a frame, an intermediate toothed wheel and a toothed wheel which is fixed to the blade serve to drive the blade in terms of rotation relative to the rotor.

The number of revolutions of the rotor of this device must be equal to the number of copies to be folded in a specific period of time.

Furthermore the blade is driven in rotation about its own axis between a retracted position and an extended position. This change of radial position relative to the rotor leads to a dynamic imbalance of the folding device.

### SUMMARY OF THE INVENTION

An object of the invention is to overcome these disadvantages and to provide a folding device which allows the production speed of the folding device to be increased and thus allows the dynamic balancing to be facilitated.

To this end, the invention provides a folding device including:
a second blade for folding one of the flat products arranged on the rotor and
second device for moving the second folding blade relative to the rotor between a second retracted passage position and a second extended folding position.

According to specific embodiments, the folding device according to the invention may include one or more of the following features:
all of the folding blades may be distributed in a uniform manner about the centre axis;
the first movement device and the second movement device may be capable of moving the first and second folding blades in a synchronous manner between the retracted position and the extended position of the associated blade so that, when one of the folding blades is in the retracted position thereof, each of the folding blades is in the retracted position thereof and, when one of the folding blades is in the extended position thereof, each of the folding blades is in the extended position thereof;
each folding blade may extends in a blade plane and the centre axis extends parallel with the blade planes;
each of the movement device may include:
a blade carrier to which the associated folding blade is fixed, the blade carrier being able to be moved in rotation relative to the rotor about a blade carrier rotation axis and
a device for driving the blade carrier about the blade carrier rotation axis,
a device for driving the or each blade carrier may include:

a fixed central toothed wheel, and

a blade carrier toothed wheel which is fixed to the associated blade carrier and which is connected to the central toothed wheel in a driving manner;
the driving device of the or each blade carrier may include an intermediate toothed wheel which is arranged on the rotor and which can be moved in rotation about an intermediate axis, this intermediate toothed wheel being in engagement with the associated blade carrier;
the folding device may include a fixed frame, and the rotor can be moved in rotation relative to this frame;
the folding device may include a folding table which is capable of supporting the flat products to be folded in a horizontal position before the folding operation, and, in their folding position, the first and second folding blades are arranged vertically;
each folding blade may extends horizontally in the folding position thereof and the folding device comprises two supports for a product to be folded, each support being capable of maintaining the flat product to be folded in a vertical position before the folding operation; and
the folding device may include switching devices which are capable of switching products to be folded alternately in the direction towards one or the other of the two supports.

The invention also provides a printing press, in particular a rotary press, comprising a folding device, wherein the folding device is a device as defined above.

### BRIEF DESCRIPTION OF THE DRAWINGS

The invention will be better understood from a reading of the following description, given purely by way of example and with reference to the drawings, in which:

FIG. 1 is a schematic perspective view of a folding device according to a first embodiment of the invention, the frame and the rotor being omitted;

FIG. 2 is a vertical section of the folding device in the plane P-P of FIG. 1;

FIG. 3 is an axial section of the device of FIG. 2;

FIGS. 4 and 5 are axial sections similar to that of FIG. 3, the device being in an intermediate position and a folding position; and

FIG. 6 is a schematic perspective view of a folding device according to a second embodiment of the invention.

### DESCRIPTION OF PREFERRED EMBODIMENTS

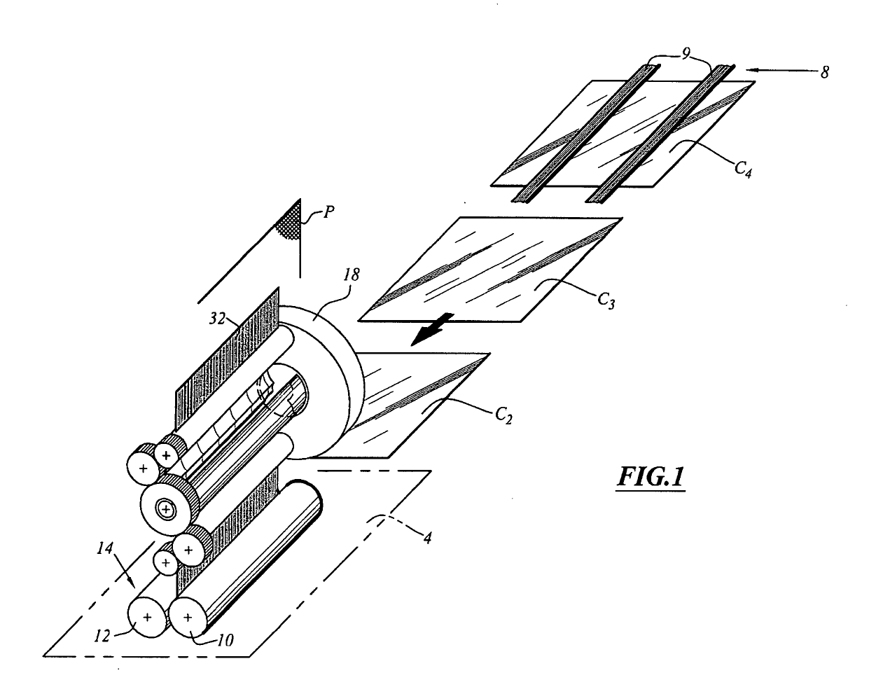

FIG. 1 is a perspective view of a folding device according to the invention, generally designated 2.

The folding device 2 is used to fold a succession of flat products, such as signatures C₁, C₂, C₃, Cₙ. The folding device 2 is part of a printing press, in particular a rotary press, which is not illustrated.

The folding device 2 comprises a folding table 4 which is capable of supporting the signatures C₁, C₂, C₃, Cₙ to be folded in a horizontal position before the folding operation. The folding device 2 further may include a fixed frame 6 which is fixed relative to the folding table 4.

The folding device 2 may further include a conveying device 8 which is capable of conveying the succession of signatures C₁, C₂, C₃, Cₙ to the folding table 4. This conveying device 8 is constituted by a plurality of conveyor belts 9.

The folding device 2 also may include a pair of folding rollers 10, 12 which are arranged below the folding table 4 and which together define a folding slot 14. Also at the location of the folding slot 14, the folding table 4 may include a through-opening 16. This through-opening 16 allows the signatures C₁, C₂, C₃, Cₙ to pass through the folding table 4 during the folding operation.

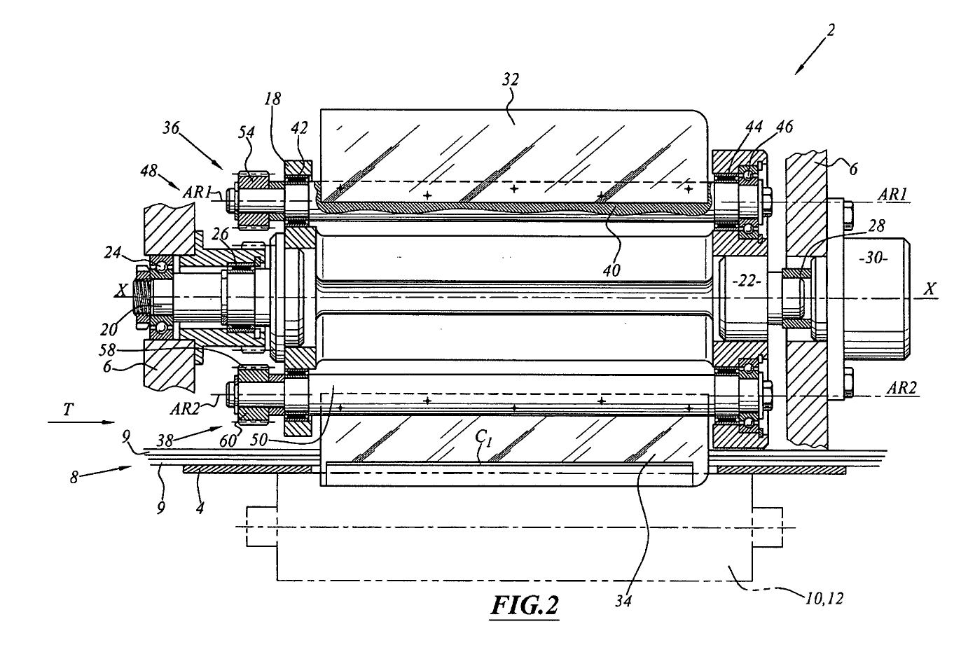

The conveying device 8 is capable of conveying the signatures C₁, C₂, C₃, Cₙ to be folded in a transport direction T. As can be seen more particularly in FIG. 2, the folding device 2 is provided with a rotor 18 which rotates freely relative to the frame 6 about a centre axis X-X. The rotor 18 is supported by the frame 6 by device of two shafts 20, 22. The first shaft 20 is accommodated in two bearings 24, 26 whilst the second shaft 22 is accommodated in a connection bush 28. The connection bush 28 is fixed to the rotor of a drive motor 30 which is capable of driving the rotor 18 relative to the frame 6 in rotation about the centre axis X-X.

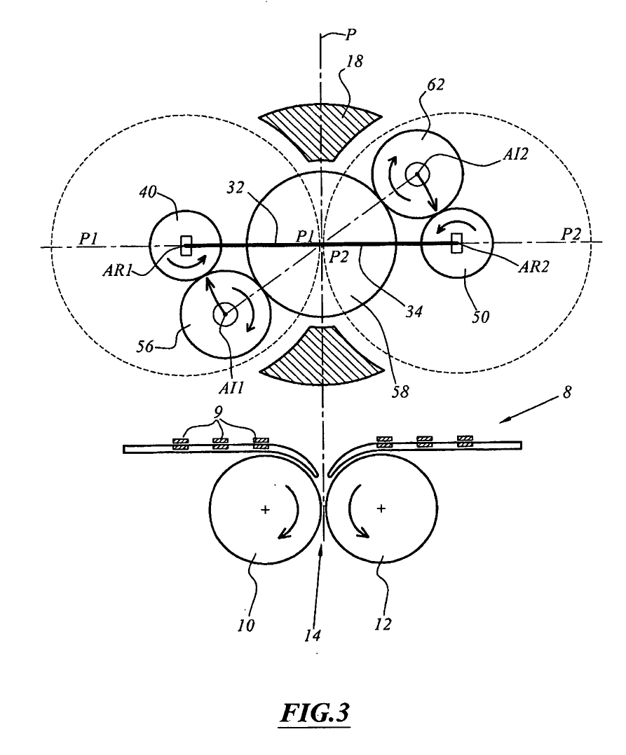

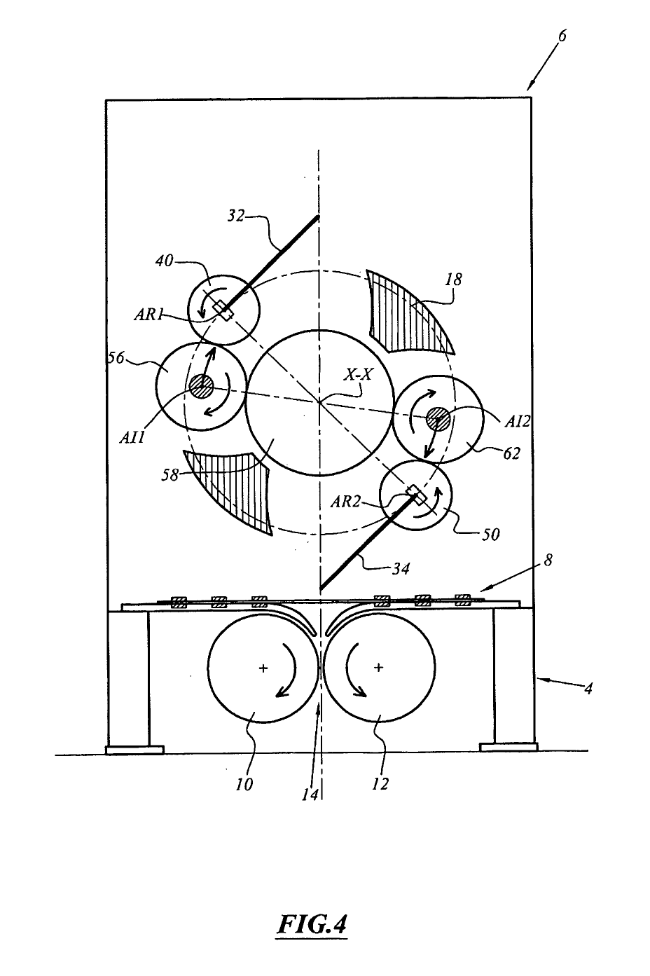

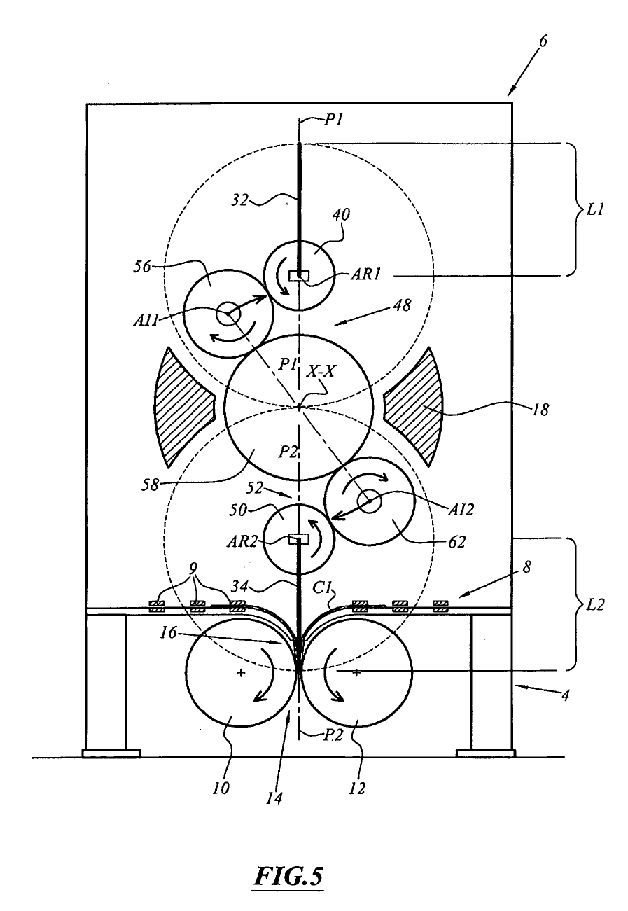

The folding device 2 may also include a first folding blade 32 and a second folding blade 34 for the flat products to be folded. The folding device 2 is provided with first device 36 for moving the first folding blade 32 relative to the rotor 18 between a first retracted passage position (see FIG. 3) and a first extended folding position (see FIG. 5), moving via an intermediate position (FIG. 4). The folding device 2 is also provided with second device 38 for moving the second folding blade 34 relative to the rotor 18 between a second retracted passage position (see FIG. 3) and a second extended folding position (see FIG. 5).

As can be seen in FIG. 5, in the folding position, the folding blades 32, 34 are arranged vertically.

As can be seen in FIGS. 3 and 5, the first folding blade 32 defines a first blade plane P1-P1 whilst the second folding blade 34 defines a second blade plane P2-P2. The centre axis X-X extends parallel with the blade planes P1-P1 and P2-P2. Furthermore the centre axis X-X extends parallel with the transport direction T.

The first movement device 36 may include a first blade carrier 40 to which the first folding blade 32 is fixed. This first blade carrier 40 can be moved in rotation relative to the rotor 18 about a first blade carrier rotation axis AR1-AR1. To this end, the first blade carrier 40 is accommodated in the rotor 18 by two needle bearings 42, 44 and a ball bearing 46. The first movement device 36 further may include a first device 48 for driving the first blade carrier 40 about the rotation axis AR1-AR1.

The second movement device 38 may include a second blade carrier 50 to which the second folding blade 34 is fixed, this second blade carrier 50 being able to be moved in rotation relative to the rotor 18 about a rotation axis AR2-AR2. The second movement device 38 may further include device 52 for driving the blade carrier 50 about the rotation axis AR2-AR2 thereof.

The first driving device 48 may include a first blade carrier toothed wheel 54 which is fixedly joined in terms of rotation relative to the first blade carrier 40. The first driving device 48 may also include a first intermediate toothed wheel 56 (see FIGS. 3 to 5). This first intermediate toothed wheel 56 can be moved in terms of rotation about its own axis AIl-AI1 relative to the rotor 18. This first toothed wheel 56 engages with a central toothed wheel 58 which is fixed coaxially relative to the axis X-X to the frame 6.

In the same manner, the second driving device 52 may include a second blade carrier toothed wheel 60 which is fixedly joined in terms of rotation to the second blade carrier 50 and a second intermediate toothed wheel 62 which can be moved in terms of rotation about a second intermediate rotation axis AI2-AI2 relative to the rotor 18. This second intermediate toothed wheel 62 engages, on the one hand, with the second blade carrier toothed wheel 60 and, on the other hand, with the central toothed wheel 58.

As can be seen particularly clearly in FIGS. 3 to 5, the blades 32, 34, the blade carriers 40, 50 and the intermediate toothed wheels 56, 62 are distributed in a uniform manner on the circumference of the rotor 18 about the centre axis X-X. In this instance, associated elements are located so as to be mutually diametrically opposed. This arrangement leads to a dynamic balance during the rotation of the rotor 18 about the axis X-X thereof. Therefore, the first movement device 36 and second movement device 38 are capable of moving the first folding blade 32 and second folding blade 34 in a synchronous manner between the associated retracted position and the associated extended position. As illustrated in FIG. 5, when the first folding blade 32 is in the extended position thereof, the second folding blade 34 is also in the extended position thereof. In the same manner, when the first folding blade 32 is in the retracted position thereof (FIG. 3), the second folding blade 34 is also in the retracted position thereof.

This arrangement further increases the dynamic balance of the folding device 2.

As can be seen in FIG. 5, the radial width L1, L2 of each blade 32, 34 is less than the distance between the central rotation axis X-X and the associated rotation axis AR1, AR2. In this manner, the folding blades 32, 34 do not come into contact during their rotation about their respective rotation axis AR1, AR2.

The folding device according to the invention operates in the following manner.

The conveying device 8 conveys the signatures C₁, C₂, C₃ to be folded onto the folding table 4, with a frequency F. During this conveying time, the blades 32, 34 are in their retracted position (see FIG. 3), allowing the signature to move onto the table 4. The rotor 18 is driven about the centre axis X-X thereof by the motor 30 at a frequency which corresponds to half of the frequency F. When one of the signatures C₁, C₂, C₃, Cₙ is located on the table 4 above the opening 16, one of the folding blades 32, 34 pushes the signature C₁, C₂, C₃, Cₙ, through the opening 16 into the folding slot 14, thus folding this signature. The folded signature is carried by the folding rollers 10, 12 in a downward direction (see FIG. 5).

It will be appreciated that the rotation frequency of the rotor 18 is less than the conveying frequency F of the signatures C₁, C₂, C₃, Cₙ. For example, for a production rate of 60,000 copies per hour, the rotation speed of the rotor 18 is 30,000 rph.

In this manner, for a specific production rate, the rotation speed of the rotor 18 may be low.

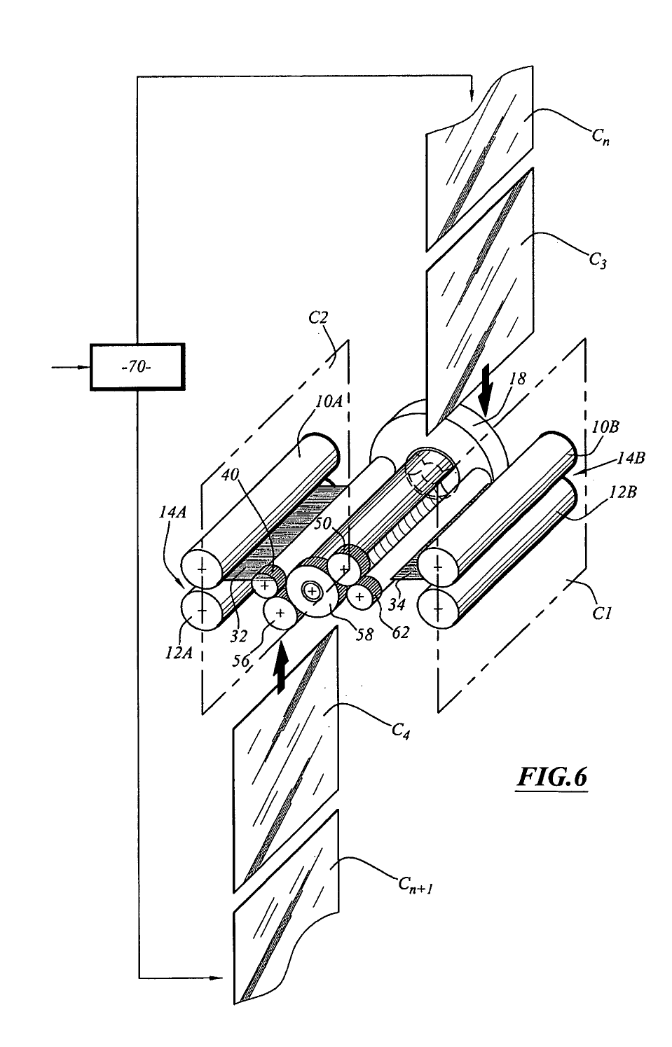

FIG. 6 illustrates a second embodiment of the folding device according to the invention.

This second embodiment differs from that described above in the following manner. Similar elements have the same reference numerals.

In the folding position, each of the folding blades 32, 34 extends horizontally and, in the retracted position thereof, each folding blade 32, 34 extends vertically.

Furthermore, the folding device 2 comprises two supports for signatures to be folded. These supports are tables which are not illustrated and are configured in the same manner as the folding table 4 with transport cords but they are arranged vertically in order to receive the folding of the signatures in a horizontal state. These supports replace the folding table 4 described above. Each of the signature supports is capable of maintaining a signature in a vertical position before the folding operation. The signatures to be folded are held so as to face each other so that the two folding blades 32, 34 may simultaneously move into contact with the associated signature C₁, C₂.

The folding device further may include two pairs of folding rollers 10A, 12A, 10B, 12B, each of which delimits a folding slot 14A, 14B. The folding device 2 further may include switching device 70 which is capable of switching the signatures to be folded alternately in the direction towards one or the other of the supports.

In this manner, for a complete rotation of the rotor 18, two signatures Cₙ, Cₙ₊₁ are folded at the same time. The rotation frequency of the rotor 18 is therefore one quarter of the conveying frequency F of the signatures. Furthermore, owing to the simultaneous folding, the forces applied to the folding device 2 are symmetrical, thus improving the quality of the folding.

In a variant, it is possible to provide the folding device 2 with more than two folding blades, for example, three folding blades. In this instance, the folding blades are also distributed in a uniform manner on the rotor 18. In the case of a folding device having three blades, the folding blades are mutually spaced-apart by 120°.

Similarly, the device for driving the folding blades between the retracted position and extended position thereof may be produced using devices other than toothed wheels, for example, using electromagnetic devices, such as electromagnets.

What is claimed is:

1-12. (canceled)

13: A device for folding flat products comprising:
a rotor freely rotatable about a center axis,
a first folding blade for folding one of the flat products, the first folding blade being arranged on the rotor,
first means for moving the first folding blade relative to the rotor between a first retracted passage position and a first extended folding position,
a second folding blade for folding one of the flat products, the second folding blade being arranged on the rotor and
second means for moving the second folding blade relative to the rotor between a second retracted passage position and a second extended folding position.

14: The folding device according to claim 13, wherein the first folding blade, second folding blade and any further folding blades are distributed in a uniform manner about the center axis.

15: The folding device according to claim 13, wherein the first movement means and the second movement means are capable of moving the first folding blade and second folding blade in a synchronous manner between the retracted position and the extended position of the associated blade so that, when one of the first and second folding blades is in the retracted position thereof, each of the first and second folding blades is in the retracted position thereof and, when one of the first and a second folding blades is in the extended position thereof, each of the first and second folding blades is in the extended position thereof.

16: The folding device according to claim 13, wherein each of the first and second folding blades extends in a blade plane and the center axis extends parallel with the blade planes.

17: The folding device according to claim 13, wherein each of the first and second movement means comprises:
a blade carrier to which the associated folding blade is fixed, the blade carrier being able to be moved in rotation relative to the rotor about a blade carrier rotation axis and
means for driving the blade carrier about the blade carrier rotation axis.

18: The folding device according to claim 17, wherein the means for driving the or each of the first and second blade carriers comprise:
a fixed central toothed wheel, and
a blade carrier toothed wheel fixed to the associated blade carrier and connected to the central toothed wheel in a driving manner.

19: The folding device according to claim 18, wherein the driving means of the or each blade carrier comprise an intermediate toothed wheel arranged on the rotor and capable of being moved in rotation about an intermediate axis, this intermediate toothed wheel being in engagement with the associated blade carrier.

20: The folding device according to claim 13, further comprising a fixed frame, and in that the rotor can be moved in rotation relative to this frame.

21: The folding device according to claim 20, further comprising a folding table capable of supporting the flat products to be folded in a horizontal position before the folding operation, and in that, in their folding position, the first and second folding blades are arranged vertically.

22: The folding device according to claim 20, wherein each of the first and second folding blades extends horizontally in the folding position thereof, and further comprising two supports for a product to be folded, each support being capable of maintaining the flat product to be folded in a vertical position before the folding operation.

23: The folding device according to claim 22, further comprising a switch capable of switching products to be folded alternately in the direction towards one or the other of the two supports.

24: A printing press comprising the folding device as recited in claim 13.

25: The printing press as recited in claim 24 wherein the printing press is a rotary printing press.

26: A printing press folder for folding signatures comprising:
a rotor freely rotatable about a center axis,
a first folding blade for folding one of the signatures, the first folding blade being arranged on the rotor,
a first blade carrier fixed to the first folding blade, the first blade carrier being able to be moved in rotation relative to the rotor about a first blade carrier rotation axis between a first retracted passage position and a first extended folding position,
a second folding blade for folding one of the flat products, the second folding blade being arranged on the rotor, and
a second blade carrier fixed to the second folding blade, the second blade carrier being able to be moved in rotation relative to the rotor between a first retracted passage position and a first extended folding position,
